(19) United States
(12) Patent Application Publication
(10) Pub. No.: US 2008/0221982 A1
(43) Pub. Date: Sep. 11, 2008

(54) Systems and methods for advertising

(76) Inventors: Robin Michel Harkins, Mendham, NJ (US); Andrew Vincent Bittman, Chester, NJ (US)

Correspondence Address: LAW OFFICES OF RITA C. CHIPPERSON, 89 HEADQUARTERS PLAZA NORTH, 14TH FLOOR, SUITE 1472, MORRISTOWN, NJ, 07960, US

(21) Appl. No.: 11/714,414

(22) Filed: Mar. 6, 2007

(51) Int. Cl. G06Q 30/00

(52) U.S. Cl. 705/14

(57) ABSTRACT

Disclosed are systems and methods for selecting and placing advertisements via one or more advertising agents and/or advertising mediums. In one aspect of the present invention, the advertising agents are retail merchants who utilize a common card processing service and the advertisements are text, logos, coupons, or the like printed on the face of a card receipt. In another aspect, the rights to print such card receipt advertisements at particular retail advertising agent locations are auctioned to potential advertisers via an Internet-based auction system. Auctions may be segmented based upon criteria such as area code, zip code, industry of product to be advertised, amount of card charge for receipt upon which the advertisement shall be printed, etc. In another aspect, the Internet-based system transmits the winning advertisements to the retail merchants in the form of an advertisement data string appended to an authorization data string.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright whatsoever.

### BACKGROUND OF THE INVENTION

Embodiments of the present invention generally relate to systems and methods for advertising. More specifically, the present invention relates to systems and methods for selecting one or more advertisements for placement with one or more advertising agents and/or in one or more advertising mediums. In some aspects of the present invention, such placement is based upon the bids placed by one or more advertisers, wherein the bids may be based upon a plurality of criteria associated with the advertising agents and/or advertising mediums.

Methods are known for printing a variety of information on store and/or customer credit card receipts. Some such methods include printing a coupon or other advertisement in addition to the other sales information that is typically found on a standard credit card receipt. For example, some such printed receipts include retail location information, sales information such as the items purchased, a coupon for purchasing an item at the retail location at a reduced price, and an advertisement for an item that may be purchased at the retail location or elsewhere. In some such methods, the coupon and advertisement are selected on a nonrandom basis (e.g., based upon the items purchased by the consumer).

In another known method which is intended for a network of member stores, a purchaser at a member store is issued a lottery number that is printed on the purchaser's receipt. A portion of the money spent within the network by the purchasers is awarded to the winner of each lottery, wherein the winner(s) are those purchasers whose issued lottery numbers match those selected in the lottery. This method provides a financial reward to patrons of the network of member stores and it attracts customers to return to the member stores, thereby serving as a form of marketing for the network. In some methods, the face and/or back sides of the receipts and/or lottery tickets may also be used as advertising space.

Another known system includes an Internet-based system for receiving advertising information, calculating and receiving fees to be paid for printing the advertising information on a receipt, and forwarding advertising information to point-of-sale (“POS”) terminals at stores, kiosks, and the like for printing on the receipts. The forwarded information may also include upgraded POS terminal software. The advertising information and amount billed for printing of same may be based upon factors such as a period for running the advertisement; characteristics of an advertisement recipient including gender, age or occupation; and the ad size. The system may also be used to prints advertisements and other information entered locally at the data entry and/or POS terminal. Additionally, the system may include a customer information input controller (for receiving customer information) and/or an advertising information retrieving unit (for selecting and retrieving advertising information stored in a storage device based upon the inputted customer information). The system is also equipped to allow local residents to advertise via the POS system and to locally disseminate information about various events being held by the local residents. In this manner, convenience stores and other similar facilities that are widely used by local residents may be used as channels of local information exchange. The receipt of information regarding local events also aids the local stores with inventory planning. The system also permits advertising costs to be set as a function of the type of advertisement or advertiser. This features allows, for example, school events with a public benefit to be placed free, while charging profit-oriented ads such as ads for private tutors or seminars.

Another known system is a POS system that allows a customer to select additional information to be printed on a standard purchase receipt or other printed medium. This system's hardware includes an input device, a printing device, a display device, and a storage device. The system's software includes a memory controller for receiving and storing advertising or other types of additional information; a display controller for displaying a list of available additional information that satisfies a particular condition input by the customer; a selection controller that receives the selection made by the customer from the displayed list; and a print data generator that generates and sends to the printing device the additional information selected by the customer as well as the other information (e.g., itemized sales data) that is normally printed on the receipt or other printed medium. The system can be applied to systems such as Automatic Teller Machines (“ATMs”), parking ticket vending equipment, and other systems issuing printed matter.

In another known system, an advertising information management server system is networked via the Internet to multiple advertisers' personal computers (“PCs”) and a POS system, wherein the POS system includes a POS terminal device having a display device and a printing device. In operation, the advertising information management sever system: stores an application page containing an advertising placement application form; sends the application page containing the application form to an advertiser's PC in response to a request from that advertiser's PC; receives and stores advertising placement information provided by the advertiser's PC in accordance with the application form; distributes specific advertising placement information data to the POS system specified by the advertiser; and controls the printing of the distributed advertising information on the POS system receiving such information. The networked system also calculates an advertising placement fee based upon the information received from the advertiser, stores and sends the placement fee to the advertiser's PC; and confirms payment of the placement fee. The advertisement placement fee is based upon conditions such as the advertising period, the advertisement distribution area, the advertising target, and type of advertisement (e.g., image, text, black and white, or color).

While the above systems and methods are directed toward the means for providing the advertisement information for printing the advertisement on a receipt or credit card statement printed at merchant locations, other systems are directed to the process of matching advertisers with advertising locations. For example, advertising systems and methods are known that are configured to receive bid requests for ad placement. The bid requests include a bid amount and an ad type, category, and/or geographic area. The ad type includes click ads, call ads, and/or call and click ads. Ad pricing is determined for ad placement using the bid requests in a dynamic price auction. The ad pricing includes a floor price and/or another ad price. The advertising systems and methods are configured to periodically modify the ad pricing according to price correlation data among ads having different ad types. Ad pricing also includes optional fixed-price advertising for set time periods for a subset of advertisers based on auction bid prices. One or more ads are placed in electronic ad spots according to the ad pricing. Search results that include the placed ads are presented in response to a user search queries.

### BRIEF SUMMARY OF THE INVENTION

Briefly stated, in one aspect of the present invention, a system for placing advertisements provided by advertisers on at least a portion of receipts generated by at least one advertising agent is provided. This system includes: at least one advertiser interface for submission of the advertisements and placement information relating to placement of the advertisements; at least one receipt printing machine for printing the receipts; at least one advertisement data server in communication with the at least one advertiser interface, the at least one advertisement data server configured to receive advertising agent information, the at least one advertisement data server configured to receive the advertisements and the placement information, the at least one advertisement data server configured to match each of the advertisements with a specific one or more of the at least one advertising agent based upon the placement information and the advertising agent information; and the advertisement data server configured to convert the advertisement to advertisement data; and least one card verification server in communication with the at least one advertisement data server and the at least one receipt printing machine, the at least one card verification server configured to receive proposed card transactions from the at least one receipt printing machine, the at least one card verification server configured to transmit an approval or a denial of the proposed card transactions to the at least one receipt printing machine, the at least one card verification server configured to communicate the approval or the denial to the advertisement data server prior to transmission of the approval or the denial to the at least one receipt printing machine for attachment of advertisement data to the transmission, and the at least one card verification server configured to transmit the advertisement data and the approval or the denial to the at least one receipt printing machine.

In another aspect of the present invention, a method for placing advertisements provided by advertisers on at least a portion of an advertising medium generated by at least one advertising agent is provided. This method includes: receiving advertising agent information for each of the at least one advertising agent; receiving the advertisements and placement information relating to placement of the advertisements from the advertisers; receiving proposed transaction data; matching each of the advertisements with at least one proposed transaction of the at least one advertising agent based upon the placement information, the advertising agent information, and the proposed transaction data; and including the at least one advertisement matched to the proposed transaction on at least a portion of the advertising medium generated by the advertising agent for the proposed transaction.

In another aspect of the present invention, a method for increasing a quantity of merchants subscribing to at least one service provided by a card processing service provider is provided. This method includes: receiving merchant information for each of the merchants, at least a portion of the merchant information including a consent to print advertisements provided by at least one advertiser on at least a portion of receipts printed by the merchant; receiving the advertisements and placement information relating to placement of the advertisements from the advertisers; receiving proposed transaction data; matching each of the advertisements with at least one proposed transaction of the at least one merchant based upon the placement information, the merchant information, and the proposed transaction data; forwarding the at least one advertisement matched to the proposed transaction to the merchant responsible for the proposed transaction for inclusion of the at least one advertisement on the at least a portion of the receipt printed for the proposed transaction by the merchant; receiving payment from the at least one advertiser for inclusion of the at least one advertisement on the at least a portion of the receipt printed for the proposed transaction by the merchant; and eliminating at least a portion of fees charged to the merchant for provision of the at least one service by paying the at least a portion of fees charged with the payment received from the at least one advertiser.

In another aspect of the present invention, a system for placing advertisements provided by advertisers on at least a portion of receipts generated by at least one advertising agent is provided. This system includes: at least one advertiser interface for submission of the advertisements and placement information relating to placement of the advertisements; at least one receipt printing machine for printing the receipts; and at least one card verification server in communication with the at least one advertiser interface and the at least one receipt printing machine, the at least one card verification server configured to receive advertising agent information, the at least one card verification server configured to receive the advertisements and the placement information, the at least one card verification server configured to receive proposed card transactions from the at least one receipt printing machine, the at least one card verification server configured to transmit an approval or a denial of the proposed card transactions to the at least one receipt printing machine, the at least one card verification server configured to match each of the advertisements with a specific one or more of the proposed card transactions based upon the placement information and the advertising agent information; and the card verification server configured to transmit each of the advertisements with the approval or the denial for the matched proposed transaction to the at least one receipt printing machine.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 depicts a flowchart of the steps of a process for selecting and placing advertisements via one or more advertising agents and/or advertising mediums via an auction in accordance with one embodiment of the present invention;

FIG. 2 is a schematic view of an Internet-based system for selecting and placing advertisements via one or more advertising agents and/or advertising mediums in accordance with one embodiment of the present invention;

FIG. 3A depicts an exemplary process for receiving bids from an advertiser via the Internet-based system depicted in FIG. 2;

FIG. 3B depicts an exemplary template for receiving an advertiser's bid in accordance with the process depicted in FIG. 3A;

FIG. 4 depicts an exemplary process for operating an auction and determining successful bidders and runners-up in accordance with one embodiment of the present invention;

FIG. 5 depicts an exemplary process for transmitting advertisements received from successful bidders to advertising agents, for the advertising agents' transmission of advertisements, and for the recording of same in accordance with one embodiment of the present invention;

FIGS. 6A and 6B depict an exemplary flowchart of the steps executed by an advertisement placement engine in accordance with one embodiment of the present invention; and

FIG. 7 depicts an exemplary advertisement printed in accordance with one embodiment of the present invention

### DETAILED DESCRIPTION OF THE INVENTION

Certain terminology may be used in the following description for convenience only and is not limiting. The words “lower” and “upper” and “top” and “bottom” designate directions in the drawings to which reference is made. The terminology includes the words above specifically mentioned, derivatives thereof and words of similar import.

Where a term is provided in the singular, the inventors also contemplate aspects of the invention described by the plural of that term. As used in this specification and in the appended claims, the singular forms “a”, “an” and “the” include plural references unless the context clearly dictates otherwise, e.g., “an advertisement” includes a plurality of advertisements. Thus, for example, a reference to “a method” includes one or more methods, and/or steps of the type described herein and/or which will become apparent to those persons skilled in the art upon reading this disclosure.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods, constructs and materials are now described. All publications mentioned herein are incorporated herein by reference in their entirety. Where there are discrepancies in terms and definitions used in references that are incorporated by reference, the terms used in this application shall have the definitions given herein.

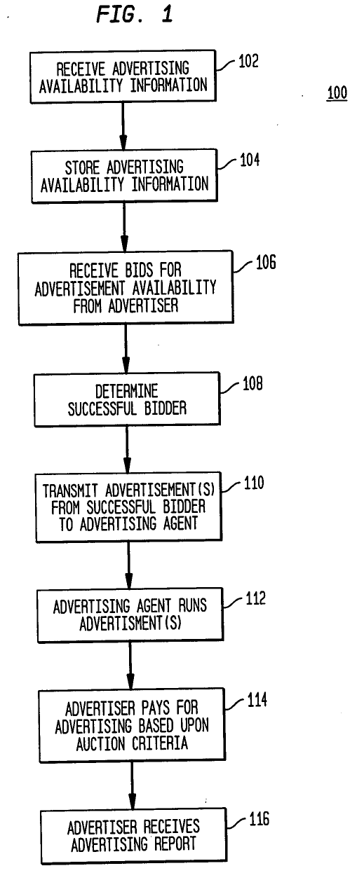

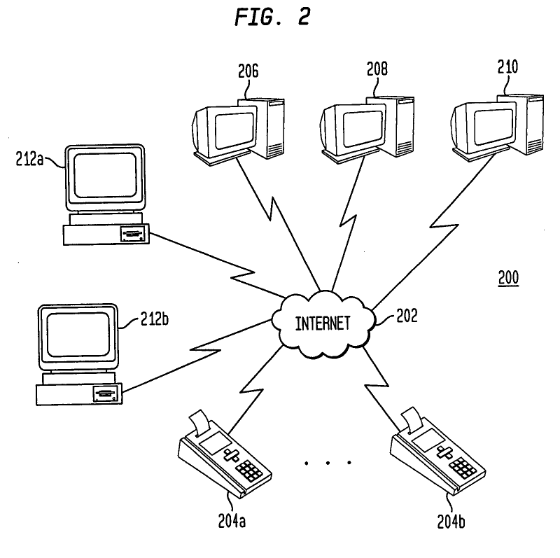

Referring first to FIG. 1, illustrated is a flow diagram of an overview of an exemplary process for selecting and placing advertisements via one or more advertising agents and/or advertising mediums via an auction in accordance with one embodiment of the present invention. Process 100 begins at 102, at which advertising availability information is received. In some embodiments of the present invention, advertising availability information is received from a card processing service provider (e.g., a service provider capable of processing cards, debit cards, etc.). That is, when an advertising agent (e.g., a merchant or other type of retail location) decides to accept cards for payment, the advertising agent typically enlists a card processing service provider for processing of the advertising agent's card transactions. This service provider typically provides the advertising agent with the necessary card processing equipment as well as connection of same to one or more card processing servers such as card verification server 206 as discussed in greater detail below with respect to FIG. 2. This allows the advertising agent's card transactions to be processed via the company's card verification server(s) 206 via methods that are commercially known. In addition to processing such transactions, these card verification servers also tally data associated with each advertising agent for purposes including, but not limited to, assessing transactions fees (e.g., such transaction fees are typically a percentage of the total card charges) for the card processing services also using commercially known methods.

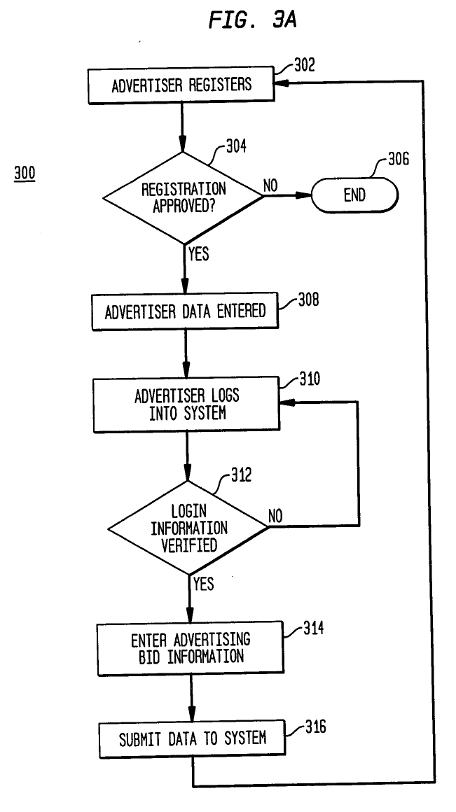

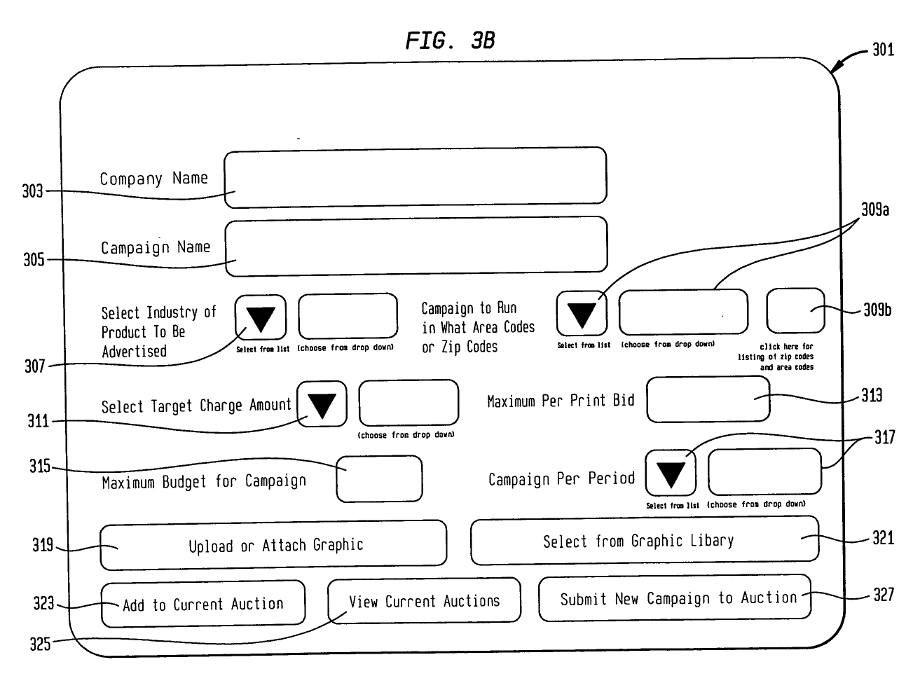

At 102, the present invention receives advertising agent information from the card processing service provider for all advertising agents that have agreed to place advertising at one or more advertising agent locations. Such information may include, but is not limited to, the advertising agents' retail locations, identification numbers, gross card sales within one or more specific time periods, average card sales within one or more specific time periods, and types of goods purchased. Receipt of such information facilitates matching of a advertising agent with whom advertising may be placed with the criteria input by one or more prospective advertisers as discussed in greater detail below with respect to FIGS. 3A, 3B, 4, and 5. Advertising agents may elect to place such advertisements in exchange for elimination or reduction of their card processing fees. That is, the revenue received by the card processing service provider from the advertisers is used to offset and/or eliminate the card processing fees typically charged to a advertising agent for provision of card processing services. In some scenarios, the revenues received from implementation of the present invention may exceed the revenue typically received from the advertising agents for such processing services.

In some embodiments of the present invention, advertising agent information is transferred directly from a card verification server such as card verification server 206 (FIG. 2) to an advertisement data server and/or database server such as advertisement data server 208 (FIG. 2) and/or database server 210 (FIG. 2). For example, in some embodiments of the present invention, advertisement data server 208 (FIG. 2) and/or database server 210 (FIG. 2) are written using the same programming and communication protocols as card verification server 206 to allow the former to easily and transparently communicate with the latter and/or to retrieve data from the latter's database. In other embodiments of the present invention in which advertisement data server 208 (FIG. 2) and/or database server 210 (FIG. 2) have differing programming and/or communication protocols, a communication interface is developed using commercially known methods to allow the former to easily and transparently communicate with the latter and/or to retrieve data from the latter's database. Such communication facilitates receipt of the advertising agent information by eliminating or minimizing manual entry of same, however, embodiments of the present invention incorporating manual entry are within the scope hereof. Furthermore, such communication provides additional benefits including, but not limited to: automatic updating of advertisement data server 208 (FIG. 2) and/or database server 210 (FIG. 2) with changes to existing advertising agents (e.g., address changes, location changes, etc.) and/or addition of new advertising agents; and clarifying information regarding new and/or existing advertising agents. Automatic receipt of such information allows advertisement data server 208 (FIG. 2) and/or database server 210 (FIG. 2) to quickly and automatically add new advertising agents such that winning advertisement bids may be almost immediately matched to such new agents. Similarly, automatic receipt of such information allows advertisement data server 208 (FIG. 2) and/or database server 210 (FIG. 2) to quickly and automatically remove inactive advertising agents such that winning advertisement bids are not matched to such inactive agents. This activity occurs with minimal or no interaction with the entity responsible for card verification server 206, thereby minimizing the cost of implementing the systems and methods of the present invention.

In one aspect of the present invention, receipt of an authorization data string that references an entity unknown to the systems and methods of the present invention, or includes data that varies from the data stored via the systems and methods of the present invention, prompts same to query card verification server database 206 to determine the information (e.g., zip code, area code, industry, etc.) necessary to add such entity to the list of available advertising agents and/or to update the information associated with such advertising agents. For example, such query may include a query of a consent or similar field to verify that the entity did in fact consent to participating in the systems and methods of the present invention as an advertising agent. However, other embodiments of updating the list of available advertising agents may be substituted without departing from the scope hereof. For example, replication may be used to ensure that the potential advertising agent database of card verification server 206 is always identical to the potential advertising agent database of advertisement data server 208 and/or database server 210.

In an alternate embodiment of the present invention, at 102, advertising availability information is received directly from an advertising agent (i.e., it is not received from, nor is it dependent upon the use of, a card processing service provider). Virtually any manner of receiving such information may be incorporated without departing from the scope of the present invention including, but not limited to, transmission of such information via electronic mail, regular mail, telephone, Internet, and text message. In some such embodiments, advertising availability information includes information regarding the availability of agents and/or agent locations willing to print advertising information on such agents' sales receipts (e.g., card receipts, cash sale receipts, etc.). In such scenarios, an advertising agent is typically any advertising agent that regularly provides sales receipts to his clientele (e.g., a retail store, a restaurant, a movie theatre, etc.) and the advertising medium is the printed sales receipt. However, it should be noted that although the systems and methods of the present invention will be primarily described herein using an exemplary embodiment of advertising agents and/or advertising agent locations available to print advertising including logos and the like via sales receipts (“the sales receipt advertising embodiment”), the methods and systems of the present invention are not so limited. The present invention may be implemented for provision of virtually any type of advertising (e.g., print, radio, television, Internet, billboard, etc.) via any type of advertising medium (e.g., newspaper, magazine, radio broadcast, Web pages, billboards, etc.) without departing from the scope of the present invention. Process 100 then proceeds to 104.

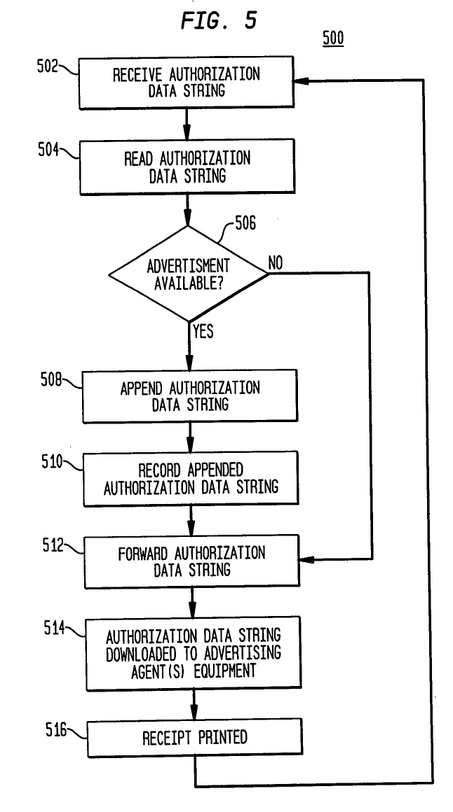

At 104, the advertising availability information received at 102 is stored. In some embodiments, this information is stored in a database (e.g., a SQL database) residing on advertisement data server 208 and/or database server 210 as described in greater detail below with respect to FIG. 2. Use of such a database facilitates electronic searching of the information for purposes such as matching advertising availability to an advertiser's bid as discussed in greater detail below with respect to FIG. 5. However, other methods of storing such information (e.g., written methods, Excel spreadsheet, etc.) may be substituted without departing from the scope of the present invention.

At 106, bids are received from the prospective advertisers. Bids may be received in virtually any form including, without limitation, price to be paid for the length of time for which the advertisement will be run, price to be paid for each advertisement printed (e.g., each advertisement printed on a sales receipt), price to be paid for the days and/or times upon which the advertising will be run, demographic to which the advertisement will be provided, location in which the advertisement will be run and/or distributed, and the agent's business type. In some embodiments of the present invention, bids are received via an Internet-based auction system as discussed in greater detail below with respect to FIG. 2. However, other methods of receiving such bids (e.g., a live auction) may be substituted without departing from the scope hereof.

After completion of 106, process 100 proceeds to 108 at which available advertising locations will be awarded to one or more successful bidders based upon the bids placed by the advertiser, the advertising location criteria submitted by the advertiser, and the quantity of matching available advertising locations. For example, available advertising locations matching the needs of a plurality of advertiser bidders may be awarded solely based upon the price (i.e., the price to be paid for placement of a specific advertisement) bid by the respective advertiser bidders. Or, alternate criteria may be used for awarding available advertising locations to a successful bidder such as, but not limited to, average price to be paid for placement of consecutive advertisements, product to be advertised, correlation between product to be advertised and products sold by the advertising agent, duration of the advertising campaign, etc.

Once one or more successful bidders have been determined, their advertisement data is then provided to the respective advertising agent at 110. For example, in our exemplary sales receipt advertising embodiment, the advertisement data (e.g., advertiser name, advertiser logo, promotional pricing data, promotional information, marketing code as discussed in greater detail below, etc.) is transmitted to the advertising agent's sales receipt processing and/or printing equipment (e.g., a card processing and/or printing machine). At 110, all data is provided to the advertising agent to allow placement of the advertisement(s).

Process 100 then proceeds to 112, at which the advertisements are run based upon the criteria provided by the advertising agent during the auction process discussed above. For example, these criteria may include a quantity of prints of the advertisement, a time period during which the advertisements will be printed, printing for customers having predetermined criteria, etc. Process 100 then proceeds to 114.

At 114, the advertiser pays for the advertising based upon the pricing determined during the auction phase discussed above. Such payment may be made directly to the advertising agent or such payment may be made to an intermediary party. For example, in our exemplary sales receipt advertising embodiment, the price paid for advertising may be paid to the card processing service provider and the collected fees may be used to offset the card processing fees charged to the advertising agent. In another example, payments may be made to an intermediary party responsible for implementing the systems and/or methods of the present invention, and such intermediary party may be responsible for sharing the received revenue with the card processing service provider as well as any other entities involved in such implementation including, but not limited to, marketing companies. Although process 100 depicts 114 as occurring subsequent to 112, advertising may also be prepaid (i.e., paid prior to 112) without departing from the scope of the present invention.

Next, process 100 proceeds to 116, at which advertising reports are generated and/or transmitted to the advertiser. Such reports may include information including, but not limited to, total value of sale (if the advertisement is printed on a sales receipt), and/or name of person or entity receiving the advertisement, as well as the date, time, and/or location of advertisement transmission. Such information may be broken down on a periodic time basis (e.g., information regarding advertisement prints per hour). Although process 100 depicts 116 as occurring subsequent to 114, reporting may be performed once or continuously at any time during or after the advertising campaign without departing from the scope of the present invention. Additionally, such reports may be transmitted to the advertiser (e.g., via electronic mail, regular mail, etc.) or they may simply be made available for retrieval by such advertiser (e.g., via log in to the advertiser's account).

Turning next to FIG. 2, depicted is an exemplary embodiment of a system for selecting and placing advertisements via one or more advertising agents and/or advertising mediums in accordance with one embodiment of the present invention. System 200 includes, inter alia, Internet 202, a plurality of sales receipt machines 204, one or more card verification servers 206, one or more advertisement data servers 208, one or more SQL servers 210, and a plurality of advertiser interfaces 212.

Sales receipt machines 204 may include, but are not limited to, POS terminals, card processing and/or printing machines, and the like. For example, sales receipts machines may be those manufactured by companies including, but not limited to, DataCard, VeriFone, PeriPheron, Hypercom, and Nurit. Such machines are typically located at the advertising agent's location, for example, at the POS. It is commercially known to connect sales receipt machines 204 to a card verification server such as card verification server 206 via an Internet connection, telephone line connection, or the like to allow them to verify card information received at the POS prior to completion of the sale via methods which are also commercially known (i.e., to approve or deny the card charge prior to allowing the purchaser to leave the retail location). Furthermore, most individuals and businesses are equipped with advertiser interfaces 212 (e.g., Internet-connected personal computers). Consequently, in some embodiments of the present invention such as that depicted in FIG. 2, it is possible to implement the present invention at a relatively low cost by simply adding advertisement data server 208 and database server 210 to an existing sales receipt processing infrastructure.

In another aspect of the present invention, advertisement data server 208 and/or database server 210 receives information from card verification server 206 regarding the sales receipt processing performed for each of the advertising agents associated therewith. That is, when a advertising agent decides to accept cards for payment, the advertising agent typically enlists a card processing company for processing of the card transactions. Such transactions are processed via the company's card verification server(s) 206 via methods that are commercially known. In addition to processing such transactions, these card verification servers also tally data associated with each advertising agent for purposes including, but not limited to, assessing transactions fees (e.g., such transaction fees are typically a percentage of the total card charges) for the card processing services also using commercially known methods.

In accordance with the present invention, advertisement data server 208 and/or database server 210 receives and stores information from card verification server 206 for all advertising agents that have agreed to participate in the advertising auction. Such information may include, but is not limited to, the advertising agents' retail locations, identification numbers, gross card sales within one or more specific time periods, average card sales within one or more specific time periods, industry, and types of goods purchased. Storage of such information facilitates matching of a advertising agent with whom advertising will be placed with the criteria input by one or more prospective advertisers as discussed in greater detail below with respect to FIG. 5. Although FIG. 2 depicts an embodiment of the present invention in which advertising agent data is stored in the same server as the card verification information, embodiments of the present invention are also envisioned in which advertising agent data is stored in a dedicated server independent of card verification server 206. In such embodiments, advertisement data server 208 and/or database server 210 are programmed to independently communicate with both the advertising agent data and card verification servers to retrieve the required information from each.

In some embodiments of the present invention, advertisement data server 208 and database server 210 each include commercially available server hardware loaded with and configured to execute server software and database software, respectively. For example, advertisement data server 208 may be loaded with server software such as Windows Server 2000, Windows Server 2003, etc. Database server 210 may be loaded with database software such as Windows SQL Server 2005, Oracle 10g, etc. However, other server and/or database software may be substituted without departing from the scope of the present invention. This software is configured to perform the features and functions of the present invention as discussed in greater detail herein. In one aspect of the present invention, database server 210 has a primary purpose of reporting data to advertisers, card processing vendors, etc. In such embodiments, database server 210 receives the necessary information for such reporting from card verification server 206 (e.g., in the form of an authorization data string) and/or advertisement data server 208.

Although advertisement data server 208 and SQL server 210 are depicted in FIG. 2 as two independent devices, these servers may be combined on a single piece of server hardware without departing from the scope of the present invention. Furthermore, although the present invention is discussed herein with respect to servers, other hardware and/or software known or not yet invented and capable of performing the same functions as such servers as also discussed herein may be substituted without departing from the scope hereof.

System 200 further includes advertiser interfaces 212. Advertiser interfaces 212 allow an advertiser's facilitator to connect to advertisement data server 208 and/or database server 210 as necessary to manage one or more advertisement bids and/or campaigns. In some embodiments, advertiser interfaces 212 are PCs equipped with an Internet connection and such computers communicate with advertisement data server 208 and/or database server 210 via Web pages served to the former by the latter. However, other types of advertiser interfaces 212 may be substituted without departing from the scope hereof including, but not limited to, personal digital assistants (“PDAs”), cellular telephones, wireless electronic mail devices (e.g., Blackberries®), and Internet-equipped televisions and radios. Also, communication mediums other than the Internet may also be substituted including, but not limited to, verbal, telephonic, and direct non-Internet computer connections (e.g., via telephone lines, cable lines, leased lines, etc.).

Referring now to FIG. 3A, illustrated is a flow diagram of one exemplary process for receiving bids from an advertiser via an Internet-based system such as system 200 (FIG. 2) as discussed generally above with respect to 106 (FIG. 1). Process 300 begins at 302, at which the advertiser registers with the Internet-based system. At 302, a user accesses one or more Web pages located on advertisement data server 208 (FIG. 2) by entering a predetermined Uniform Resource Locator (“URL”), for example, in the user's Internet browser as available via advertiser interface 212. Such Web pages provide one or more data entry Web pages that facilitate entry of the advertiser's pertinent registration information such as name, contact information, annual sales volume, annual marketing budget, desired user log in name, desired log in password, advertiser's industry(ies), corporate information, name of advertiser's facilitator, if any, etc. Upon full entry of the registration information, such information may be saved in advertisement data server 208 (FIG. 2) and/or database server 210 (FIG. 2). Process 300 then proceeds to 304.

At 304, the registration information saved at 302 is reviewed by, for example, a human operator or a computerized algorithm to determine whether such advertiser will be allowed to become a member of the auction system. The criteria for making such determination may include, but is not limited to, the advertiser's credit rating, the type of products offered by the advertiser, age of advertiser's business, existing advertisers in the auction system offering similar or competing products and/or services, and prior dealings with advertiser. If the advertiser is denied membership, process 300 proceeds to 306 at which it ends. Otherwise, if the advertiser's membership is approved, process 300 proceeds to 308.

At 308, the advertiser's information (e.g., account information, log in information, billing address, etc.) is entered into the auction system, for example, via programming such information in advertisement data server 208 and/or database server 210. This data entry allows system 200 to verify the advertiser's log in information when such advertiser attempts to log in to system 200. Furthermore, subsequent to log in by the advertiser, such data entry allows any information entered by the advertiser (e.g., information required to place one or more bids) to be thereafter associated with the advertiser via such log in information.

Next, at 310, the advertiser logs in to the auction system using the username and password selected during the registration process (i.e., at 302). The log in information is verified by advertisement data server 208 using any one of many commercially known methods at 312. If the log in information is not successfully verified at 312, process 300 returns to 310 to allow the advertiser another log in attempt. Or, if the log in information is successfully verified at 312, process 300 proceeds to 314.

At 314, the advertiser is prompted to enter information corresponding to an advertisement bid. In one exemplary embodiment of the present invention, the bid is entered via a Web-page based template such as template 301 as depicted in FIG. 3B. In some embodiments of the present invention, template 301 is displayed to the user via a Web page provided by advertisement data server 208 via known methods. Subsequently, the advertiser's facilitator enters the data in the data entry fields. However, other methods of receiving advertisement bid(s) may be substituted without departing from the scope of the present invention.

In embodiments of the present invention incorporating a data template such as template 301 of FIG. 3B, the facilitator is first prompted to enter the company name in company name data field 303. In some embodiments of the present invention, the company name data field may be automatically populated based upon the company name associated with the advertiser's log in data, however, in other embodiments such as that depicted in FIG. 3B, an advertiser may manually enter such information.

Next, the advertiser's facilitator may enter a campaign name in campaign name data field 305. This name may be any name that allows the advertiser to associate the advertisement bid with the intended advertisements. For example, if the advertiser is submitting an advertisement bid for the purpose of advertising a “Buy One, Get One Free” promotion, the campaign name may be similarly titled (e.g., “Buy One, Get One Free” campaign). This name will allow advertisers who are running multiple campaigns or submitting multiple bids to easily identify each campaign.

An industry of the product to be advertised by the advertiser may also be selected. In our exemplary embodiment, this industry is selected from a drop down list displayed by clicking industry drop-down arrow 307 to display a list of all industries. Once displayed, a user may simply highlight the industry of the product to be promoted. This information allows the submitted advertisement to be matched with the most suitable advertising agent based upon the industry and/or types of products sold by such agent. This information also allows the systems and methods of the present invention to evaluate same to ensure that the advertisement bid, if successful, is not matched with a advertising agent that provides a competitive product. Or, alternatively or in addition, this information may be used to ensure that the advertising agent with which the advertisement bid is matched is not matched with a second advertisement bid submitted by a competing advertiser (i.e., a second advertiser that is advertising a product that competes with the product offered by the first advertiser). Although embodiments of the present invention incorporating template 301 of FIG. 3B accept information for matching advertisement bids based upon industry, other methods of matching such bids may be substituted without departing from the scope of the present invention. For example, advertisement bids may be matched to one or more advertising agents based upon criteria including, but not limited to, average age of purchaser and education level of purchaser. Virtually any criteria for matching the advertisement bids to one or more advertising agents may be substituted without departing from the scope of the present invention. Such matching may be performed by an advertisement placement engine as discussed in greater detail below, however, the present invention is not so limited.

In another aspect of the present invention, the advertiser may limit the advertising campaign to one or more zip codes and/or area codes, or the advertiser may choose to run different advertising campaigns in different zip codes and/or area codes. For example, a first advertising campaign may be targeted to one or more zip codes and/or area codes having a wealthier demographic (e.g., a free spa treatment with every $500 purchased) and a second advertising campaign may be targeted to one or more zip codes and/or area codes having a less wealthy demographic (e.g., 10% off all purchases made prior to a predetermined date). Or, multiple advertising campaigns may be targeted to different zip codes and/or area codes based upon an age demographic. For example, a first campaign targeted to an older demographic may offer free seminars for strategies for spending money during retirement and/or low risk investments, wherein a second campaign targeted to a younger demographic may offer free seminars for college savings plans and/or higher risk investment strategies.

In the embodiment of the present invention depicted in FIG. 3B, one or more zip codes and/or area codes may be selected by either selecting them from a drop down list displayed by clicking code drop-down arrow 309a or by checking code checkbox 309b for a display of all available zip codes and/or area codes. In either scenario, once the list of zip codes and/or area codes has been displayed, a user may simply highlight the zip codes and/or area codes in which the advertiser would like the advertising campaign to be promoted. Such area codes and/or zip codes may be international or domestic without departing from the scope hereof. Although embodiments of the present invention incorporating template 301 of FIG. 3B select a demographic based upon area code and/or zip code, other methods of selecting a demographic may be substituted without departing from the scope of the present invention. For example, if the advertiser wishes to place its advertisement with an advertising agent who is a restaurateur, it may select the advertising agent based upon the average cost per meal at each of the restaurateur's locations. Or, alternatively, if the advertising agent is a retail location, the demographic may be based upon the average charge value or the average charge value per location. Virtually any criteria for segmenting the advertising agent's clientele into demographics may be substituted without departing from the scope of the present invention.

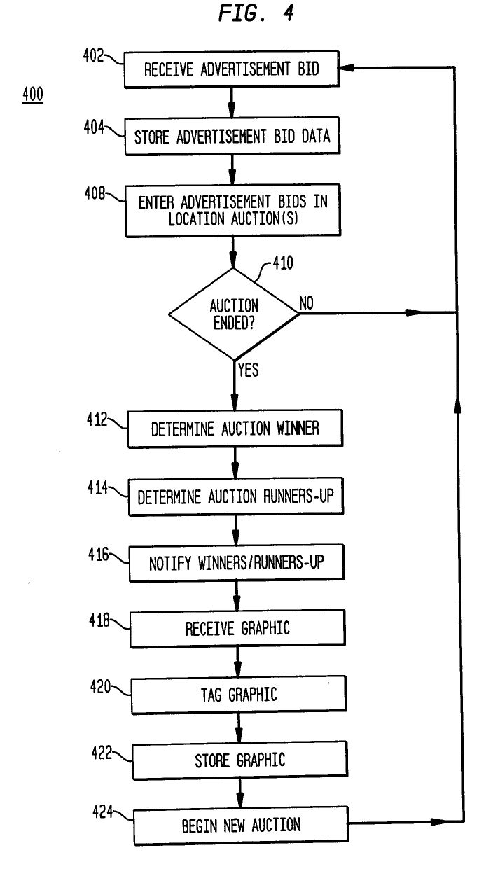

A target charge amount is also requested by template 301. This value is the value of the purchase on which the advertisement will be printed. For example, as discussed in greater detail below with respect to 408 of FIG. 4A, the advertisement auction may be segmented into multiple auctions based upon an area code and a target charge amount. That is, the advertiser may select the actual charge amount required for placement of the advertiser's advertisement upon the related card receipt. For example, low, medium, and high ranges may be defined as discussed below with respect to 408 of FIG. 4A. Upon submission of the advertisement bid via template 301, the bid will be placed in a location auction that corresponds to the target charge amount selected by the advertiser's facilitator. In our exemplary embodiment, this target charge amount is selected from a drop down list displayed by clicking target charge amount drop-down arrow 311 to display a list of all charge values. Once the list of target charge amounts has been displayed, a user may simply highlight the desired one.

Next, the advertiser's facilitator is prompted to enter a maximum per print bid in maximum per print bid data field 313. This entry is a dollar or cents value that corresponds to the maximum price that the advertiser is willing to pay the advertising agent for each transmission of an advertisement of the respective advertising campaign. For example, in our sales receipt advertising embodiment, this value corresponds to the maximum price that the advertiser is willing to pay each time an advertisement is printed on a sales receipt at the advertising agent's location. However, in other embodiments of the present invention, the maximum price per print may correspond to the maximum price the advertiser is willing to pay for each display of an advertisement on items including, but not limited to: the advertising agent's Web page, the advertising agent's electronic billboard, the advertising agent's printed publication (e.g., newspaper, magazine, journal, etc.), and the advertising agent's electronic mail messages. Any method of transmitting an advertisement may be substituted without departing from the scope of the present invention.

Similarly, maximum budget for campaign data field 315 allows the advertiser to enter a maximum price to be paid for the entire advertising campaign. This allows the advertiser to set a limit on the total cost of the advertising campaign. The present invention will divide this maximum budget for campaign value by the actual per print bid price (as discussed in greater detail below) to determine how many times the advertisement may be transmitted without exceeding the maximum budget for campaign and it will internally limit such transmissions to ensure that the advertiser's budget is maintained. This calculation will also account for any taxes, surcharges, or other fees to be paid by the advertiser and will reduce the number of advertisement transmissions accordingly to maintain the advertisers per campaign budget.

Thereafter, the advertiser's facilitator selects a campaign run period by selecting it from a drop down list displayed by clicking run period drop-down arrow 317 for a list of all available run periods. A run period is the period in which the winning advertisement will be transmitted by the advertising agent. Once the list of run periods has been displayed, a user may simply highlight the run period in which the advertiser would like the advertising campaign to be promoted. This run period data limits the time frame in which the advertisements included in the advertising campaign may be transmitted. That is, the present invention will prevent transmission of such advertisements prior to the run period and will stop all such transmissions upon the expiration of the run period (or earlier if the maximum budget for campaign value has been met prior to the end of the run period).

In addition to accepting data, template 301 also allows the advertiser's facilitator to perform functions via clicking of the respective button such as upload/attach graphic button 319, select graphic button 321, add to current auction button 323, view current auctions button 325, and submit new campaign button 327.

By selecting upload/attach graphic button 319, an advertiser is allowed to upload an advertising graphic to the advertisement data server 208 and/or database server 210 for storage therein, for example, in a graphic library associated with the user's log in information. Or, alternatively, the advertising graphic may be transmitted to such servers as an electronic mail or other form of attachment. The advertising graphic includes all information to be transmitted as an advertisement as a part of the advertising campaign. For example, such graphic may be a coupon, a text advertisement, the advertiser's logo, an offer for sale, a promotional offer, a rebate offer, or the like. Uploading and/or attachment of this graphic allow the advertiser to store it in its library for future use. Such storage also allows the system such as system 200 to access the graphic upon the occurrence of a successful bid by the advertiser. This access also allows the system to automatically transmit, or otherwise forward, the advertisement to the advertising agent for transmission to its clientele as per the criteria entered by the advertiser.

In some embodiments of the present invention, upon uploading or attachment of a graphic, software tools are provided to the user to allow addition of text thereto. For example, in the exemplary system depicted in FIG. 2, such tools may be provided by advertisement data server 208, or a sub-component thereof, via Internet 202 in the form of, for example, multiple Web pages. Such tools minimize the advertiser's cost for creation of the advertisement. However, this option is not required for implementation of the present invention.

If the advertiser has previously stored advertising graphics as discussed immediately above, the advertiser's facilitator has the option of selecting the advertising graphic(s) to be associated with the current campaign by simply clicking select graphic button 321. Selection of this button allows the advertiser's facilitator to view the advertising graphics stored within the advertiser's library and to select one or more graphics therefrom to be included in the new advertising campaign.

Once all information has been entered for the current advertising campaign, process 300 proceeds to 316 (FIG. 3A), at which the entered data is submitted to the system (i.e., advertisement data server 208 and/or database server 210). At 316, the advertiser's facilitator may submit the new campaign to the advertising auction by clicking submit new campaign button 327. When submitted to the advertising auction, the entered information becomes an advertisement bid that competes with other advertisement bids potentially aimed at the same area codes and/or zip codes and target charge amount. Subsequently, the advertiser may also elect to be sent a list of all available zip codes and/or area codes for one or more specific auctions via electronic mail, conventional mail, facsimile or other method. The systems and methods of selecting the winner(s) of each available advertising agent/medium in accordance with one embodiment of the present invention are discussed in greater detail below with respect to FIGS. 4 and 5. In some embodiments of the present invention, an advertiser may submit multiple advertisement bids for a single auction; however, the present invention is not so limited.

As an alternative to submitting a new advertising campaign to the advertising auction, at 316 (FIG. 3A), the advertiser's facilitator has the alternate option of adding the entered information to a current advertisement bid by clicking on add to current auction button 323. This selection allows the facilitator to update the information associated with an existing advertisement bid. That is, the information entered in template 301 will augment and/or replace the information previously entered for a pending advertisement bid. For example, selection of add to current auction button 323 allows an advertiser to change the advertisement that is currently being printed or that is scheduled to be printed. Or, alternatively, the advertiser may add additional advertisements as well as a request to rotate the printing of all advertisements associated with the advertising campaign. However, once an auction has been closed, the advertiser will no longer have the ability to change its bid price.

In yet another alternative, the advertiser's facilitator may click view current auctions button 325 to simply view all pending advertisement bids. In one embodiment, the pending advertisement bids are listed by their campaign names, as previously entered in campaign name data field 305. To view additional information for a particular campaign, the advertiser's facilitator simply enters the campaign name or selects same from a list (e.g., a drop down list). In one aspect of the present invention, the details for each particular campaign and its associated auction are able to be viewed by the respective advertiser only, which allows such advertisers to modify a current bid or advertising campaign during the auction period. In some embodiments of the present invention, each advertiser may only view their respective auction information. In other embodiments, each advertiser may review all competing bids during the auction process to allow such advertiser to attempt to outbid the other advertisers for a specific advertising location, target charge amount, etc.

Referring now to FIG. 4, depicted is a flowchart of a method (i.e., process 400) for determining a successful bidder and runners-up in accordance with one embodiment of the present invention. Process 400 begins at 402, at which advertisement bids are received. For example, advertisement bids may be received by advertisement data server 208 and/or database server 210 of system 200 (FIG. 2) when a user transmits such data thereto via a fillable Web page template and/or an Internet connection or the like as discussed above in greater detail with respect to FIGS. 3A and 3B. Process 400 then proceeds to 404, at which the information associated with each advertisement bid is stored in advertisement data server 208 and/or database server 210 via commercially known methods.

Next, at 408, the advertisement bid(s) are entered into a location auction. In some embodiments of the present invention, available advertising is segmented based upon area code or zip code as well as the target charge amount. That is, advertising availability is first segmented by area code or zip code and each area code or zip code is further segmented into low, medium, and high zones, wherein low, medium, and high correspond to the target charge amount. For example, the winner of the auction for the low zone will have its advertisements printed upon all receipts having a total purchase price less than $44.99. Similarly, the winner of the auction for the medium zone will have its advertisements printed upon all receipts having a total purchase price between $45.00 and $99.99. And, the winner of the auction for the high zone will have its advertisements printed upon all receipts having a total purchase price greater than $100.00. In such a scenario, three auctions may be established for each area code (e.g., 973_Low, 973_Medium, and 973_High) and all advertising agents located within the “973” area code print the winning advertisements for all three auctions, however, the actual printed advertisement is dependent upon the total purchase price for each receipt. Although the present invention is described herein as being segmented into three target charge amount zones, any quantity of such zones may be substituted without departing from the scope of the present invention.

In one aspect of the present invention, the advertiser has the option of selecting the desired location auction upon submission of its bid. For example, in the embodiment of the present invention depicted in FIGS. 3A and 3B, the area code or zip code is selected via clicking code drop-down arrow 309a or by checking code checkbox 309b for selection of same as discussed in greater detail above with respect to FIG. 3B. Similarly, the advertiser may further define the location auction in which it wishes to participate by selecting a target charge amount via target charge amount drop-down arrow 311 as also discussed in greater detail above with respect to FIG. 3B. Based upon the inputted information, the systems and methods of the present invention will automatically enter the submitted advertisement bid into the appropriate location auction. Furthermore, if a particular advertiser wishes to have the exclusive rights to an entire area code (e.g., the 973 area code), such advertiser may simply submit three advertisement bids, wherein each of such bids has a different target charge amount. Although the location auctions of the present invention has been described herein as varying by area code and target charge amount, other criteria may be substituted without departing from the scope of the present invention. For example, location auctions may be segmented based upon one or more criteria including, but not limited to, zip code, average charge value, and advertising agent industry. However, other embodiments of the present invention are envisioned in which the systems and/or methods of the present invention determine the proper location auction for each advertisement bid. Also, in some embodiments of the present invention, location auctions are omitted and all advertisement bids are placed into a solitary auction.

In another aspect of the present invention, each location auction awards the rights to advertise via one or more advertising agents and/or locations for a predetermined run period. For example, if the run period is ten days and the auction winner has bid a maximum per print price of $2.00 and a maximum budget for the advertising campaign of $100.00, the winning advertiser's advertisement will be printed a maximum of fifty times (i.e., the maximum budget for the advertising campaign divided by the maximum per print price). Alternatively, if the quantity of sales receipts printed during the run period is less than the maximum number of allowed prints (i.e., fifty), and then the advertiser is charged for the actual number of prints printed during the run period multiplied by the maximum per print price. Although this exemplary embodiment of the present invention includes a predetermined run period, location auctions may include alternate run mechanisms without departing from the scope of the present invention. For example, each auction may award a specific quantity of prints and such prints may start subsequent to the last print of a previous auction.

Process 400 then proceeds to 410 at which process 400 determines whether the location auction has ended. In one embodiment of the present invention each location auction runs for a predetermined period of time (e.g., 5 days). If this time period has not elapsed (i.e., the auction has not ended), process 400 returns to 408 at which additional advertisement bid(s) are accepted into the current auction. Alternatively, if at 410, the auction has ended, process 400 proceeds to 412 at which an auction winner is determined.

At 412, in some embodiments of the present invention including our exemplary embodiment, the winner is the entity that has bid the highest maximum budget for campaign price, for example, as entered in maximum budget for campaign data field 315 (FIG. 3B). However, alternate methods of selecting a winner may be substituted including, but not limited to, the entity that has bid the highest maximum price per print. Also, in our exemplary embodiment of the invention, three winners are selected for each area code (i.e., one winner is selected for each location auction 973_Low, 973_Medium, and 973_High). Process 400 then proceeds to 414.

At 414, the runners-up are determined. In some embodiments of the present invention including our exemplary embodiment, the first runner up is the entity that has bid the second highest maximum budget for campaign price, for example, as entered in maximum budget for campaign data field 315 (FIG. 3B). The second runner-up is the entity that has bid the third highest maximum budget for campaign price, the third runner-up is the entity that has bid the fourth highest maximum budget for campaign price, and so on. However, alternate methods of selecting runners-up may be substituted including, but not limited to, selecting the runners-up in order of the entities that have bid the highest maximum price per print. Process 400 then proceeds to 416.

At 416, all winners and, optionally, runners-up are notified. Such notification may be performed via any commercially known method including, but not limited to, posting an electronic message in the advertiser's online account (as established via process 300), electronic mail message, telephone call, and regular mail. Optionally, such notification may include instructions for uploading and/or correlating one or more graphics to be associated with the winning advertisement bid. That is, the uploading of the graphics discussed above with respect to FIGS. 3A and 3B may be performed after or prior to completion of the auction. If this uploading occurs prior to the completion of the auction, upon such completion, the advertiser notifies or confirms with system 200 the graphics to be associated with the winning bid. Upon receipt of such notification, the graphic is tagged as discussed in greater detail below with respect to 420 of FIG. 4. It is important to note that although the systems and methods of the present invention are referred to herein as including advertisement in the form of “graphics”, such advertisements may also be non-graphical text advertisements without departing from the scope of the present invention. Process 400 then proceeds to 418.

At 418, if the advertiser is submitting or uploading a graphic subsequent to completion of the auction, such advertisements are received by system 200 in the same manner as discussed above with respect to FIGS. 3A and 3B, and process 400 proceeds to 420.

Next, at 420, each graphic included with the advertisement bid is tagged with a unique identifier that indicates information such as, but not limited to, advertising campaign run period, advertising campaign area code and/or zip code, industry of product to be advertised, and target charge amount. The identifier may be in the form of a filename; however, the present invention is not so limited. Furthermore, the identifier may include letters, numbers, or the like, wherein each letter or number represents a specific type of data. For example, in one embodiment of the present invention, the identifier is an alphanumeric filename, wherein the first three indicia are numbers that indicate the advertiser, the subsequent four indicia are numbers that represent the run period, the subsequent two indicia are numbers that represent the industry of the advertised product(s), the subsequent two indicia are numbers that indicate the advertiser's placement in the auction (e.g., winner, first runner-up, second runner-up, etc.), and the subsequent two letters indicate the order in which a variety of advertisements will be placed. The last two letters allow multiple advertisements to be included in a single advertisement bid as well as instructions regarding how the advertisements are to be printed (e.g., rotationally, in prints of three, etc.).

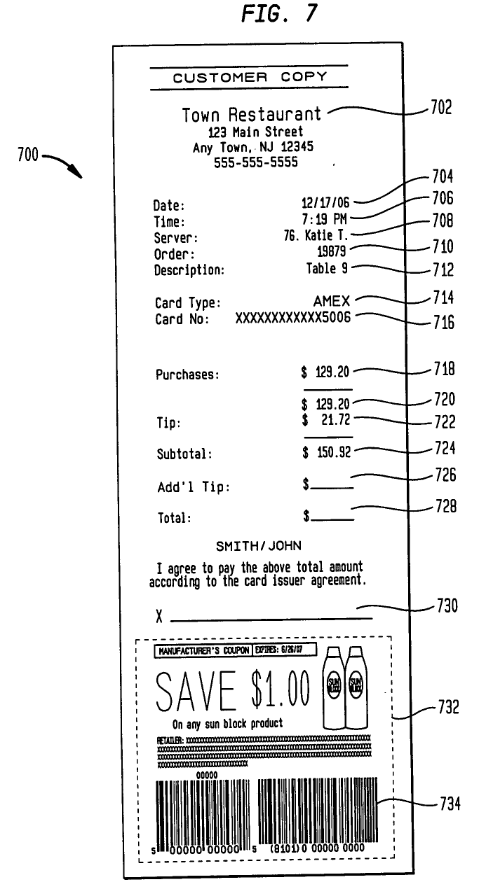

Optionally, this identifier may be incorporated in the reports discussed in further detail below as a means of identifying each printed advertisement. Additionally, this identifier may be used for tracking purposes to identify the graphics that were being printed concurrent with or immediately following a sales increase for the advertised product. In this manner, advertisement effectiveness may be gauged. In yet another embodiment, this identifier is used as a marketing code such as marketing code 734 as discussed in greater detail below with respect to FIG. 7.

Next, at 422, the tagged graphics are stored via commercially known methods and process 400 proceeds to 424. At 424, a new auction is initiated. In our exemplary embodiment of the present invention, a new auction for advertising in the run period subsequent to the run period of the previously-ended auction may be initiated. However, virtually any form of new auction may be initiated without departing from the scope of the present invention. The continuously occurring auctions ensure a constant flow of advertisements between the receipt printing systems (e.g., sales receipt processing machines 204 and/or card processing server 206) and the advertisement provision systems (e.g., advertisement data server 208 and/or database server 210). Optionally, either automatically or upon the selection of the advertiser, the winning and/or losing bids of the previously-ended auction is automatically re-entered in the new auction.

The advertising campaigns bid upon by the selected runners-up may be wholly or partially implemented if the advertisement campaigns of the winning and/or more highly ranked runner-up advertisers are exhausted prior to the end of the respective auction's run period. For example, in an auction in which a winning bidder is selected based upon the maximum campaign budget and Advertiser #1 bids a maximum campaign budget of $1000 with a maximum per print price of $10, Advertiser #2 bids a maximum campaign budget of $500 with a maximum per print price of $2, and Advertiser #3 bids a maximum campaign budget of $750 with a maximum per print price of $5, the winning advertiser will be Advertiser #1 (due to the maximum campaign budget of $1,000), the first runner-up will be Advertiser #2 (due to the maximum campaign budget of $750), and the second runner-up will be Advertiser #3 (due to the maximum campaign budget of $500). In this example, Advertiser #1 is entitled to 100 prints (i.e., $1,000 maximum campaign budget divided by the $10 maximum per print price), Advertiser #2 is entitled to 250 prints (i.e., $500 maximum campaign budget divided by the $2 maximum per print price), and Advertiser #3 is entitled to 150 prints (i.e., $750 maximum campaign budget divided by the $5 maximum per print price). Consequently, if Advertiser #1's advertisement is printed 100 times prior to the expiration of the run period, Advertiser #1's campaign is exhausted and the first runner-up's campaign (i.e., Advertiser #3) will begin. Similarly, if Advertiser #3's advertisement is printed 150 times prior to the expiration of the run period, Advertiser #3's campaign is exhausted and the second runner-up's campaign (i.e., Advertiser #2) will begin. This process continues until the run period expires or until all advertisement campaigns of all winners and runners-up have been completed. The aforementioned method illustrates one exemplary process of printing advertisements for runners-up, however, other methods (e.g., winners may be ranked based upon maximum per print price rather than maximum campaign budget) may be substituted without departing from the scope of the present invention.

Turning now to FIG. 5, depicted is an exemplary process for transmitting advertisements from successful bidders to advertising agents and for the advertising agents' transmission of advertisements in accordance with one embodiment of the present invention. Process 500 begins at 502 at which advertisement data server 208 receives an authorization data string from card verification server 206. That is, whenever a card purchase is made at an advertising agent's location, the purchase is locally processed via the advertising agent's card processing machine (e.g., sales receipt processing machine 204). As a part of such processing, information regarding the card charge to be made by the purchaser is transmitted to card verification server 206, which is responsible for denying or approving such charge. Card verification server 206 then performs the operations (e.g., verification of the card charge with the lending institution responsible for the respective card) necessary to provide such approval or denial according to commercially known systems and methods. Once an approval or denial has been generated by card verification server 206, it generates an authorization data string to be returned to the sales receipt processing machine 204 also using commercially known systems and methods. However, when the systems and methods of the present invention are implemented, card verification server 206 is re-programmed to transmit the generated authorization data string to advertisement data server 208 in lieu of sales receipt processing machine 204, thereby allowing receipt of such authorization data string at 502. Process 500 then proceeds to 504.

At 504, advertisement data server reads the data contained in the authorization data string. Such data may include, but is not limited to, advertising agent location, total charge requested, type of card utilized (e.g., credit card, debit card, etc.), time, date, and advertising agent identifier (e.g., an identifier provided to the advertising agent by the card provider). Process 500 then proceeds to 506.

The information read at 504 is then used at 506 to determine whether an advertisement has been matched with the pending transaction. In other words, the information read at 504 is compared to the criteria (e.g., run period, target charge amount, etc.) associated with the winning and runners-up advertisements selected via process 400 (FIG. 4) to determine whether any such advertisement should be printed at the conclusion of the pending transaction.

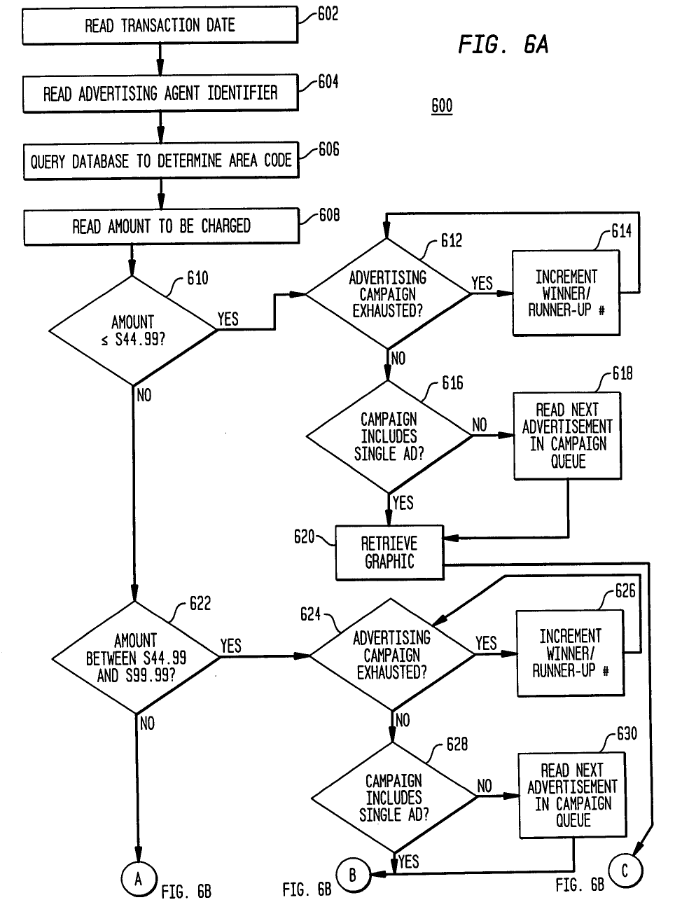

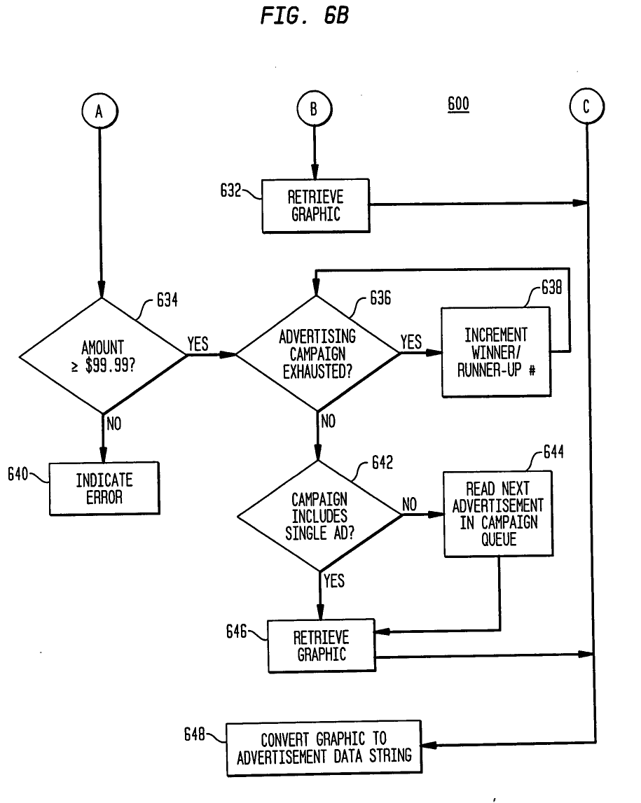

In one aspect of the present invention, the advertisement(s) to be matched to each pending transaction are determined by an advertisement placement engine executed by advertisement data server 208. Referring now to FIGS. 6A and 6B, depicted is an exemplary embodiment of a flowchart of the steps executed by an advertisement placement engine in accordance with one embodiment of the present invention. For example, in one embodiment of the present invention, the advertising agent identifier, the requested charge amount, and the date of the pending transaction are compared to the advertisements that have been awarded placement via the location auctions as discussed in greater detail above with respect to FIG. 4. In some embodiments of the present invention, the winning advertiser is awarded the exclusive right to have its advertisement(s) printed on all receipts printed within the respective auction's zone. For example, in the 973_Low auction discussed above with respect to 408 of FIG. 4, the advertisement of the winner of this auction will be matched to all pending transactions processed by card processing machines located in the 973 area code (the “973 card processing machines). Then, whenever a transaction is processed during the auction's run period by a 973 card processing machine and the purchase total for the receipt is within the “Low” range (i.e., in our exemplary embodiment, the purchase total is less than $49.99), the winning advertisement will be matched to the pending transaction and the advertisement will be printed upon the receipt resulting therefrom. Such matching and printings will occur until the advertiser's campaign budget is exhausted or until expiration of the run period, whichever occurs first. In scenarios in which the advertiser's campaign budget is exhausted prior to the expiration of the run period, the advertisement placement engine will cause the first runner-up's advertisement to be matched to all pending transactions of all 973 card processing machines such that all receipts resulting therefrom in the “Low” range will then include the first runner-up's advertisement. This will also continue until the first runner-up's campaign budget is exhausted or until expiration of the run period, whichever occurs first. In scenarios in which the first runner-up's campaign budget is exhausted prior to the expiration of the run period, the advertisement placement engine will cause the second runner-up's advertisement to be matched to the pending transactions and transmitted to all 973 card processing machines such that all receipts resulting therefrom in the “Low” range will then include the second runner-up's advertisement. This process continues until the expiration of the run period or until the exhaustion of the advertising campaign budget of all runners-up. However, it should be noted that embodiments of the present invention in which the runners-up are omitted are envisioned. Also, other methods of matching advertisements to pending transactions and/or selecting the card processing machines to which the advertisements will be transmitted may be substituted without departing from the scope of the present invention.

As depicted in FIGS. 6A and 6B, process 600 begins with 602 at which the date of the pending card transaction is read from the authorization data string received from card verification server 206. This date allows advertisement placement engine to determine the proper auction for which the winning advertisement should be matched to the pending transaction since each auction is operated for a distinct run period. That is, the date of the pending transaction must fall within the run period of the applicable location auction.

Next, at 604, the advertising agent identifier is read from the authorization data string received from card verification server 206 and process 600 proceeds to 606. At 606, such identifier is used to query the database to determine the area code (or other criteria) of the advertising agent that has requested the pending transaction. In system 200 (FIG. 2), such database resides on advertisement data server 208 and/or database 210. Retrieval of the area code information also allows advertisement placement engine to identify the advertisement to be matched to the pending transaction by identifying the location auction applicable to the transaction. That is, the applicable location auction is the auction associated with the run period, as determined at 602, and the area code as determined in 604 and 606. Process 600 then proceeds to 608.

At 608, the amount to be charged as per the pending transaction is read from the authorization data string received from card verification server 206. This amount further identifies the local auction applicable to the pending transaction. For example, if the amount to be charged is $15.00 and the area code has been determined to be 973 at steps 604 and 606, advertisement placement engine then determines that the 973_Low auction for which the date of the pending transaction falls within its run period is the proper transaction for determining the advertiser who has won the right to have its advertisement printed with the pending transaction. Process 600 then proceeds to 610.

At 610, the amount to be charged as per the pending transaction is compared to the low limit for the AreaCode_Low auction. In the depicted embodiment, such cutoff value is $44.99, therefore, the amount to be charged is queried to determine if it is less than or equal to such value. If yes, process 600 proceeds to 612, at which the campaign information for the current winner/runner-up is queried to determine whether it has been exhausted. That is, the first current winner/runner-up is the winner, who has won the right to print a predetermined quantity of prints during a specific run period as discussed in greater detail herein. Advertising placement engine queries the quantity of the winner's advertisement(s) that have already been printed to determine whether the winner's campaign has been exhausted (i.e., the quantity of awarded prints has been printed). Such query occurs at 612. If, at 612, the current winner/runners-up's campaign has been exhausted, process 600 proceeds to 614 at which the winner/runner-up is incremented. That is, if the winner's campaign is determined to be exhausted, the winner/runner-up is incremented such that the first runner-up's campaign is printed. Alternatively, if the first runner-up's campaign is determined to be exhausted, the winner/runner-up is incremented such that the second runner-up's campaign is printed and so on until all campaigns of all winners and runners-up have been exhausted.

If the current winner/runner-up's campaign has not been exhausted, process 600 proceeds to 616 at which the current winner/runner-up's campaign is queried to determine whether it includes a single or multiple advertisements. If multiple advertisements are included, process 600 proceeds to 618 at which process 600 reads the next advertisement available in the current campaign's queue. For example, if two advertisements have been included in the current campaign and the advertiser has elected to rotate such advertisements, querying the next advertisement in the queue notifies process 600 of the advertisement that is next in the rotation. Once this information has been read at 618, or if at 616 the campaign is determined to include a single advertisement, process 600 proceeds to 620. At 520, the graphic associated with the next advertisement in the campaign queue or the single advertisement, respectively, is retrieved and process 600 proceeds to 648. At 648, the retrieved graphic is converted to an advertisement data string to allow it to be appended to an authorization data string as discussed in greater detail below with respect to FIG. 5.

Alternatively, if at 610, the amount to be charged as per the pending transaction is not less than the low limit, process 600 proceeds to 622, at which such amount is compared to the medium limits for the AreaCode_Medium auction. In the depicted embodiment, such limits are $44.99 and $99.99. Therefore, the amount to be charged is queried to determine if it is greater than $44.99 and less than $99.99. If yes, process 600 proceeds to 624, at which the campaign information for the current winner/runner-up is queried to determine whether it has been exhausted as discussed in greater detail above with respect to 612. If, at 624, the current winner/runners-up's campaign has been exhausted, process 600 proceeds to 626 at which the winner/runner-up is incremented. That is, if the winner's campaign is determined to be exhausted, the winner/runner-up is incremented such that the first runner-up's campaign is printed. Alternatively, if the first runner-up's campaign is determined to be exhausted, the winner/runner-up is incremented such that the second runner-up's campaign is printed and so on until all campaigns of all runners-up have been exhausted.

If the current winner/runner-up's campaign has not been exhausted, process 600 proceeds to 628 at which the current winner/runner-up's campaign is queried to determine whether it includes a single or multiple advertisements. If multiple advertisements are included, process 600 proceeds to 630 at which process 600 reads the next advertisement available in the current campaign's queue. Once this information has been read at 630, or if at 628 the campaign is determined to include a single advertisement, process 600 proceeds to 632 (FIG. 6B), at which the graphic associated with the next advertisement in the campaign queue or the single advertisement, respectively, is retrieved and process 600 proceeds to 648. At 648, the retrieved graphic is converted to an advertisement data string to allow it to be appended to an authorization data string as discussed in greater detail below with respect to FIG. 5.

Alternatively, if at 622, the amount to be charged as per the pending transaction is not between the medium limits, process 600 proceeds to 634 (FIG. 6B), at which such amount is compared to the high limit for the AreaCode_High auction. Referring now to FIG. 6B, in the depicted embodiment, such limit is $99.99. Therefore, the amount to be charged is queried to determine if it is greater than or equal to $99.99. If no, an error has occurred as the amount has not fallen within the limits of the low, medium, or high auction, therefore, process 600 proceeds to 640 at which the error is indicated to the user. If, at 634, the amount to be charged is greater than or equal to $99.99, process 600 proceeds to 636, at which the campaign information for the current winner/runner-up is queried to determine whether it has been exhausted as discussed in greater detail above with respect to 612. If, at 636, the current winner/runners-up's campaign has been exhausted, process 600 proceeds to 638 at which the winner/runner-up is incremented. That is, if the winner's campaign is determined to be exhausted, the winner/runner-up is incremented such that the first runner-up's campaign is printed. Alternatively, if the first runner-up's campaign is determined to be exhausted, the winner/runner-up is incremented such that the second runner-up's campaign is printed and so on until all campaigns of all runners-up have been exhausted.

If the current winner/runner-up's campaign has not been exhausted, process 600 proceeds to 642 at which the current winner/runner-up's campaign is queried to determine whether it includes a single or multiple advertisements. If multiple advertisements are included, process 600 proceeds to 644 at which process 600 reads the next advertisement available in the current campaign's queue. Once this information has been read at 644, or if at 642 the campaign is determined to include a single advertisement, process 600 proceeds to 646, at which the graphic associated with the next advertisement in the campaign queue or the single advertisement, respectively, is retrieved and process 600 proceeds to 648. At 648, the retrieved graphic is converted to an advertisement data string to allow it to be appended to an authorization data string as discussed in greater detail below with respect to FIG. 5. Process 600 then ends.

In an alternate embodiment of the present invention, rather than selecting a target charge amount (i.e., the total card charge), the advertiser selects advertising agent locations based upon their historical average card charge. In such scenarios, the current advertisement is matched to a pending transaction and transmitted only to those advertising agents within the selected area code (i.e., the one selected in the advertiser's bid as entered, for example, via template 301 (FIG. 3)) that have a historical average card charge within the average card charge range selected by the advertisement during the bidding process. However, alternate methods of selecting card processing machines (other than target charge amount within an area code or average card charge within an area code) for printing of advertising may be substituted without departing from the scope of the present invention.

Referring back to FIG. 5, if no advertisement has been matched to the pending transaction, process 500 proceeds to 512 at which the authorization data string is forwarded, or returned, to card verification server 206 in the same form in which it was originally received (i.e., the authorization data string is not appended with advertising data). Alternatively, if at 506, an advertisement has been matched with the pending transaction, process 500 proceeds to 508.

At 508, the current advertisement (i.e., the advertisement next in the queue for a particular advertiser) uploaded by the winning advertiser during submission of the advertiser's advertisement bid is packaged for transmission to the advertising agent(s). In our exemplary embodiment, the advertisement is packaged in the form of an advertisement data string that is appended to the authorization data string. That is, the advertisement data string is inserted into the authorization data string at the end prior to the “end” command. This advertisement data string may be created by advertisement data server 208 and/or database server 210. In some embodiments of the present invention, the advertisement data string is written in the same language and using the same programming conventions as are used to create the authorization data string to allow the machine receiving the advertisement data string (e.g., sales receipt machine 204) to read such string in the same manner in which it reads the authorization data string. This allows transmission of the advertisement data string to occur without modification of the existing card processing equipment since, from the respective of sales receipt machine 204, it is simply reading a lengthier authorization data string which it processes in an identical manner to a shorter, unappended authorization data string. However, the advertisement data string of the present invention provides such machines with the information necessary to print the desired advertisements on the printed receipts in addition to the other typically printed information (e.g., total charge amount, authorization code, advertising agent location, date, time, etc.).

In some embodiments of the present invention, the advertisement data string provides the card processing machine with the ability to print a graphical advertisement in a high resolution and/or color format. The advertisement data string includes a high resolution color image for printing by the card processing machine, however, the actual print quality and/or color will be determined by the specifications of the printer installed at the advertising agent's location. However, the ability to print a high resolution color graphic via a card processing machine text printer is not required to implement the systems and methods of the present invention. Process 500 then proceeds to 510.

Next, process 500 then proceeds to 510, at which each printing of each advertisement is recorded by advertisement data server 208 by recording the appendage of the authorization data string as well as the information associated therewith. That is, upon appendage of the authorization data string, it is assumed that the appended advertisement is successfully printed at the advertising agent location. Therefore, tallying such appendages and their associated information allows the number of printed advertisements to be tallied along with associated information including, but not limited to, advertising agent(s) who printed the advertisement, location of the advertising agent at which the advertisement was printed, and total card charge of the receipt upon which the advertisement was printed. This information may then be transmitted to database server 210 for analysis, storage, billing and/or reporting. In one aspect of the present invention, the quantity of advertisement prints is monitored by the advertisement placement engine in order to allow it to determine when an advertisement will no longer be printed and when a new advertisement will be printed, however, the present invention is not so limited.

In another aspect of the present invention, the quantity of advertisement prints is recorded for billing purposes. That is, the systems and methods of the present invention prepares a bill for each advertiser based upon the quantity of advertisement prints and the maximum per print price, as entered by the advertiser during the bidding process as discussed in greater detail above with respect to FIGS. 3A and 3B. Similarly, the systems and methods of the present invention record and/or reformat the information regarding the quantity of advertisement prints, location(s) of each print, total purchase price of the receipt upon which each advertisement was printed, etc. such that a detailed report regarding the printed advertisements may be provided to the advertiser or other interested party(ies).

In one embodiment of the present invention, the advertising fees paid by the advertiser are retained by the entity responsible for providing the card processing services and such collected fees are used to offset or eliminate the fees charged to the advertising agents for their card processing services. However, in alternate embodiments of the present invention, the collected advertising fees may be paid directly to the advertising agents or an alternate entity without departing from the scope of the present invention. Process 500 then proceeds to 512.

At 512, either the original authorization data string (if no advertisement was matched to the pending transaction at 506) or the appended authorization data string (if an advertisement was matched to the pending transaction at 506) is returned to card verification server 206 and process 500 proceeds to 514.

At 514, the authorization data string (original or appended) is transmitted from card verification server 206 to sales receipt processing machine 204 in the same manner in which transmission of an authorization data string occurs in commercially available credit card processing systems. In our exemplary system depicted in FIG. 2, such transmission occurs via the Internet since both systems are connected thereto; however, other communication methods may be substituted without departing from the scope of the present invention.

In an alternate embodiment of the present invention, in lieu of appending the advertisement data string to the authorization data string, request of the authorization data string simply triggers a transmission of the advertisement data string to the requesting sales receipt machine 204. That is, the advertisement data string is transmitted independently from the authorization data string, but such transmission is triggered by the request for the authorization data string. However, other methods of requesting transmission of the advertisement data string may be substituted. In yet other alternate embodiments of the present invention, advertisements are transmitted to the card processing machines in a form other than an advertisement data string including, but not limited to, in the form of a software patch and in the form of a sales printing machine firmware update.

Next, at 516, upon receiving the authorization data string, if such data string has been appended with an advertisement data string, sales receipt machine 204 prints the winning advertisement for the current run period on the card receipt. This advertisement is printed using the same methods with which card receipts are currently printed with the exception that a slightly longer receipt (e.g., two inches longer) is required to accommodate the advertisement. An exemplary example of a printed advertisement is depicted in FIG. 7. As shown, receipt 700 is in the form of a standard receipt that includes typical sales receipt information such as advertising agent location name and address 702, date 704, time 706, server 708, order number 710, table number 712, card type 714, card number 716, purchase price 718, total purchase price 720, tip 722, subtotal 724, additional tip 726, total 728, and signature line 730. However, in addition to this typical sales receipt information, receipt 700 also includes advertisement 732, which has been transmitted to the card processing machine (e.g., sales receipt machine 204) in accordance with the systems and methods of the present invention. As depicted in FIG. 7, advertisement 732 may be a single high resolution image containing both textual and graphical elements. However, varying types of advertisements (e.g., text-only, graphics-only, etc.) may be substituted without departing from the scope of the present invention.

In one aspect of the present invention, advertisement 732 includes marketing code 734 which allows the advertiser to monitor the effectiveness of the advertising campaign. As depicted in FIG. 7, marketing code 734 is a bar code printed at the bottom of advertisement 732. Marketing code 734 may include information such as the date, time, and location of printing of the advertisement, as well as the advertising agent responsible therefore and the charge amount for the receipt upon which the advertisement was printed. In the depicted scenario, when the coupon is redeemed to the advertiser for reimbursement, the advertiser may scan marketing code 734 to read the information contained therein for the purpose of determining which marketing campaigns are having the greatest success. However, other forms of marketing codes including, but not limited to, numerical codes may be substituted. Also, in lieu of including marketing code 734 within advertisement 732, such code may be printed independently before or after printing of advertisement 732. These marketing codes are presented by the consumer receiving the receipt when such consumer purchases or inquires about the product advertised on the receipt, thereby allowing the advertiser to correlate the potential consumer of the advertised product with the advertising campaign of the present invention. However, inclusion of such code is not necessary to implement the systems and methods of the present invention. After the receipt has been printed, process 500 returns to 502 at which another authorization data string is received. That is, process 500, or multiples thereof, continually repeats as necessary to process all authorization data strings received by advertisement data server 208.

Although FIG. 5 depicts a method of transmitting advertisements to card processing machines that are provided by an entity other than the entity implementing the systems and methods of the present invention, alternate embodiments are envisioned in which the same entity that provides the advertising system also provides the card processing services and/or card processing machines. For example, the systems and methods of the present invention may be directly implemented by a card processing service provider who elects to add such systems and methods to its existing infrastructure. In such scenarios, the functions and/or algorithms of advertisement data server 208 and/or database server 210 may be programmed for performance on card verification server 206 such that the latter server is the only server required to implement the present invention.

Alternatively, advertisement data server 208 and database server 210 may be implemented independent of card verification server 206, however, one entity may be responsible for advertisement data server 208, database server 210, and sales receipt processing machines 204 and, optionally, card processing server 206. In such an embodiment, advertisement data server 208 and database server 210 may communicate directly with sales receipt processing machines 204 via a proprietary or open protocol, thereby eliminating the need to transmit advertisement data to sales receipt processing machines 204 via an advertisement data string or other similar mechanism. In other words, when one entity is responsible for advertisement data server 208, database server 210, and sales receipt processing machines 204 and, optionally, card processing server 206, all equipment may be created using the same communication protocols, which allows data regarding advertising campaigns to be directed transmitted to sales receipt processing machines 204 since they are programmed to receive such information and they communicate with the same language as advertisement data server 208, database server 210, and/or card processing server 206. Furthermore, in such embodiments, sales receipt processing machines 204 may be pre-programmed with software specifically configured for receiving advertisements and the data relating thereto (e.g., advertisement campaign run period, target charge amount, maximum budget for campaign, etc.).

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A system for placing advertisements provided by advertisers on at least a portion of receipts generated by at least one advertising agent comprising:
at least one advertiser interface for submission of said advertisements and placement information relating to placement of said advertisements;
at least one receipt printing machine for printing said receipts;
at least one advertisement data server in communication with said at least one advertiser interface, said at least one advertisement data server configured to receive advertising agent information, said at least one advertisement data server configured to receive said advertisements and said placement information, said at least one advertisement data server configured to match each of said advertisements with a specific one or more of said at least one advertising agent based upon said placement information and said advertising agent information; and said advertisement data server configured to convert said advertisement to advertisement data; and
at least one card verification server in communication with said at least one advertisement data server and said at least one receipt printing machine, said at least one card verification server configured to receive proposed card transactions from said at least one receipt printing machine, said at least one card verification server configured to transmit an approval or a denial of said proposed card transactions to said at least one receipt printing machine, said at least one card verification server configured to communicate said approval or said denial to said advertisement data server prior to transmission of said approval or said denial to said at least one receipt printing machine for attachment of advertisement data to said transmission, and said at least one card verification server configured to transmit said advertisement data and said approval or said denial to said at least one receipt printing machine.

2. A system according to claim 1,
wherein said placement information includes at least one price to be paid by said advertiser for said placement; and
wherein said price is at least one of the group consisting of a maximum per print price, a maximum budget per campaign, an average price to be paid for placement of consecutive ones of said advertisements, and combinations thereof.

3. A system according to claim 2,
wherein said at least one price is placed into at least one auction;
wherein said matching includes comparing each of said prices received from said advertisers to determine at least one of the group consisting of a winner, a runner-up, and combinations thereof; and
wherein at least one of the group consisting of a winner, a runner-up, and combinations thereof is awarded placement of said at least one advertisement with at least a portion of said at least one advertising agent.

4. A system according to claim 3,
wherein said at least one advertisement of a first of said runners-up is placed upon exhaustion of said placement of said at least one advertisement of said winner; and
wherein said at least one advertisement of each subsequent one of said runners-up is placed upon exhaustion of said placement of said at least one advertisement of said previous one of said runners-up.

5. A system according to claim 3,
wherein said auction is a location auction; and
wherein said price is placed into at least one of said location auctions based upon said placement information.

6. A system according to claim 3, wherein said placement is awarded for at least one of the group consisting of a quantity of said placements of said at least one advertisement, a time period, and combinations thereof.

7. A system according to claim 1, wherein each of said at least one advertising agent consents to printing of said advertisements on said at least a portion of said receipts generated by said advertising agents in exchange for elimination or reduction of card processing fees.

8. A system according to claim 1, wherein said advertising agent information includes at least one of the group consisting of a retail location of said advertising agent, an identification number of said advertising agent, gross card sales of said advertising agent, average card sales of said advertising agent, types of goods sold by said advertising agent, area code in which said advertising agent is located, zip code in which said advertising agent is located, an industry of said advertising agent, and combinations thereof.

9. A system according to claim 1,
wherein said advertisement data server reads proposed transaction data included in said approval or said denial received from said card verification server; and
wherein said advertisement data server performs said matching based at least in part upon such proposed transaction data.

10. A system according to claim 9, wherein said proposed transaction data includes at least one of the group consisting of a target charge amount, a date, an identification number of said advertising agent requesting said proposed transaction, an area code of said advertising agent requesting said proposed transaction, a zip code of said advertising agent requesting said proposed transaction, and combinations thereof.

11. A system according to claim 1, wherein advertising agent information is retrieved automatically from said at least one card verification server by said at least one advertisement data server to perform at least one of the group consisting of adding a new one of said advertising agents to said advertisement data server, updating said advertising agent information in said advertisement data server for an existing one of said advertising agents, deleting advertising agent information in said advertisement data server for an inactive one of said advertising agents, deactivating advertising agent information in said advertisement data server for said inactive one of said advertising agents, and combinations thereof.

12. A system according to claim 11, wherein advertising agent information is retrieved automatically by said advertisement data server from said approval or said denial whenever said advertising agent information varies from said advertising agent information in said advertisement data server.

13. A system according to claim 1 further comprising:
at least one database server for storage of at least one of the group consisting of said placement information, said advertising agent information, said advertisements, said advertisement data, and combinations thereof.

14. A system according to claim 13, wherein advertising agent information is retrieved automatically from said at least one card verification server by said at least one database server to perform at least one of the group consisting of adding a new one of said advertising agents to said database server, updating said advertising agent information in said database server for an existing one of said advertising agents, deleting advertising agent information in said database server for an inactive one of said advertising agents, deactivating advertising agent information in said database server for said inactive one of said advertising agents, and combinations thereof.

15. A system according to claim 14, wherein advertising agent information is retrieved automatically by said database server from said approval or said denial whenever said advertising agent information varies from said advertising agent information in said database server.

16. A system according to claim 1, wherein a first database of at least one of the group consisting of said advertisement data server, said database server, and combinations thereof and a second database of said card verification server are synchronized via replication.

17. A system according to claim 1,
wherein said approval and said denial are in the form of authorization data strings;
wherein said advertisement data is an advertisement data string; and
wherein said advertisement data string is inserted into the authorization data string prior to an end command.

18. A system according to claim 1, wherein said at least one advertiser interface, said at least one receipt printing machine, said at least one advertisement data server, and said at least one card verification server communicate via an Internet connection.

19. A system according to claim 1, wherein said at least one advertiser interface is at least one of the group consisting of a personal computer, a personal digital assistant, a cellular telephone, a wireless electronic mail device, an Internet-equipped television, an Internet-equipped radio, and combinations thereof.

20. A system according to claim 1, wherein said placement information is at least one of the group consisting of an area code in which said receipt is generated, a zip code in which said receipt is generated, an industry of a product in said at least one advertisement, a target charge amount, an average charge amount, a duration of said placement, correlation between said product in said at least one advertisement and advertising agent products sold by said advertising agents, an average age of purchaser, an average education level of purchaser, and combinations thereof.

21. A system according to claim 1, wherein said advertisement includes at least one marketing code.

22. A system according to claim 1, wherein said at least one advertisement data server stores at least one of the group consisting of advertisement placement information, advertising availability information, advertising agent information, said advertisements, and combinations thereof.

23. A system according to claim 1,
wherein said advertisement is tagged with an identifier; and
wherein said identifier indicates at least a portion of said placement information.

24. A system according to claim 1, wherein said matching is performed by an advertisement placement engine in said advertisement data server.

25. A system according to claim 1, wherein said advertisement data facilitates printing of at least one of the group consisting of a high resolution graphic, a color graphic, and combinations thereof.

26. A system according to claim 1 further comprising:
tallying said attachment of said advertisement data to said transmission for recording at least one of the group consisting of a quantity of said advertisements printed on said receipts, said advertising agents responsible for printing said advertisements, a date of said printing of said advertisements, a time of said printing of said advertisements, a charge amount of said receipt upon which said advertisement is printed, and combinations thereof.

27. A method for placing advertisements provided by advertisers on at least a portion of an advertising medium generated by at least one advertising agent comprising the steps of:
receiving advertising agent information for each of said at least one advertising agent;
receiving said advertisements and placement information relating to placement of said advertisements from said advertisers;
receiving proposed transaction data;
matching each of said advertisements with at least one proposed transaction of said at least one advertising agent based upon said placement information, said advertising agent information, and said proposed transaction data; and
including said at least one advertisement matched to said proposed transaction on at least a portion of said advertising medium generated by said advertising agent for said proposed transaction.

28. A method according to claim 27,
wherein said advertising medium is a printed sales receipt; and
wherein said including said at least one advertisement is printing said at least one advertisement on said advertising medium.

29. A method according to claim 27,
wherein said proposed transaction data is received in the form of an authorization data string; and
wherein said including said at least one advertisement includes the sub-steps of:
inserting an advertisement data string in said authorization data string; and
transmitting said advertisement data string and said authorization data string to a receipt printing machine.

30. A method according to claim 27,
wherein said placement information includes at least one price to be paid by said advertiser for said placement; and
wherein said price is at least one of the group consisting of a maximum per print price, a maximum budget per campaign, an average price to be paid for placement of consecutive ones of said advertisements, and combinations thereof.

31. A method according to claim 30,
wherein said at least one price is placed into at least one auction;
wherein said matching includes comparing each of said prices received from said advertisers to determine at least one of the group consisting of a winner, a runner-up, and combinations thereof; and
wherein at least one of the group consisting of a winner, a runner-up, and combinations thereof is awarded placement of said at least one advertisement with at least a portion of said at least one advertising agent.

32. A method according to claim 31,
wherein said at least one advertisement of a first of said runners-up is placed upon exhaustion of said placement of said at least one advertisement of said winner; and
wherein said at least one advertisement of each subsequent one of said runners-up is placed upon exhaustion of said placement of said at least one advertisement of said previous one of said runners-up.

33. A method according to claim 31,
wherein said auction is a location auction; and
wherein said price is placed into at least one of said location auctions based upon said placement information.

34. A method according to claim 31, wherein said placement is awarded for at least one of the group consisting of a quantity of said placements of said at least one advertisement, a time period, and combinations thereof.

35. A method according to claim 27, wherein each of said at least one advertising agent consents to said including of said at least one advertisement matched to said proposed transaction on at least a portion of said advertising medium generated by said advertising agent for elimination or reduction of card processing fees.

36. A method according to claim 27, wherein said advertising agent information includes at least one of the group consisting of a retail location of said advertising agent, an identification number of said advertising agent, gross card sales of said advertising agent, average card sales of said advertising agent, types of goods sold by said advertising agent, area code in which said advertising agent is located, zip code in which said advertising agent is located, an industry of said advertising agent, and combinations thereof.

37. A method according to claim 27, wherein said proposed transaction data includes at least one of the group consisting of a target charge amount, a date, an identification number of said advertising agent requesting said proposed transaction, an area code of said advertising agent requesting said proposed transaction, a zip code of said advertising agent requesting said proposed transaction, and combinations thereof.

38. A method according to claim 27, wherein said placement information is at least one of the group consisting of an area code in which said advertising medium is generated, a zip code in which said advertising medium is generated, an industry of a product in said at least one advertisement, a target charge amount, an average charge amount, a duration of said placement, correlation between said product in said at least one advertisement and advertising agent products sold by said advertising agents, an average age of purchaser, an average education level of purchaser, and combinations thereof.

39. A method according to claim 27, wherein said advertisement includes at least one marketing code.

40. A method according to claim 27,
wherein said advertisement is tagged with an identifier; and
wherein said identifier indicates at least a portion of said placement information.

41. A method according to claim 29 further comprising:
tallying said inserting of said advertisement data string in said authorization data string for recording at least one of the group consisting of a quantity of said advertisements printed on said receipts, said advertising agents responsible for printing said advertisements, a date of said printing of said advertisements, a time of said printing of said advertisements, a charge amount of said receipt upon which said advertisement is printed, and combinations thereof.

42. A method according to claim 27, said advertising agent is a merchant.

43. A method according to claim 27 further comprising the step of:
receiving payment from said advertisers for said including of said at least one advertisement matched to said proposed transaction on at least a portion of said advertising medium generated by said advertising agent.

44. A method according to claim 45, wherein said payment minimizes or offsets the card processing fees paid by said at least one advertising agent to at least one card processing service provider.

45. A method according to claim 27, wherein said at least one advertising agent provides consent for including said at least one advertisement matched to said proposed transaction on said at least a portion of said advertising medium generated by said advertising agent for said proposed transaction in exchange for a reduction in fees to be paid by said at least one advertising agent for provision of services.

46. A method according to claim 47, wherein said services are card processing services.

47. A method according to claim 47, wherein said advertising agent information is received from at least one provider of said services.

48. A method for increasing a quantity of merchants subscribing to at least one service provided by a card processing service provider comprising the steps of:
receiving merchant information for each of said merchants, at least a portion of said merchant information including a consent to print advertisements provided by at least one advertiser on at least a portion of receipts printed by said merchant;
receiving said advertisements and placement information relating to placement of said advertisements from said advertisers;
receiving proposed transaction data;
matching each of said advertisements with at least one proposed transaction of said at least one merchant based upon said placement information, said merchant information, and said proposed transaction data;
forwarding said at least one advertisement matched to said proposed transaction to said merchant responsible for said proposed transaction for inclusion of said at least one advertisement on said at least a portion of said receipt printed for said proposed transaction by said merchant;
receiving payment from said at least one advertiser for inclusion of said at least one advertisement on said at least a portion of said receipt printed for said proposed transaction by said merchant; and
eliminating at least a portion of fees charged to said merchant for provision of said at least one service by paying said at least a portion of fees charged with said payment received from said at least one advertiser.

49. A system for placing advertisements provided by advertisers on at least a portion of receipts generated by at least one advertising agent comprising:
at least one advertiser interface for submission of said advertisements and placement information relating to placement of said advertisements;
at least one receipt printing machine for printing said receipts; and
at least one card verification server in communication with said at least one advertiser interface and said at least one receipt printing machine, said at least one card verification server configured to receive advertising agent information, said at least one card verification server configured to receive said advertisements and said placement information, said at least one card verification server configured to receive proposed card transactions from said at least one receipt printing machine, said at least one card verification server configured to transmit an approval or a denial of said proposed card transactions to said at least one receipt printing machine, said at least one card verification server configured to match each of said advertisements with a specific one or more of said proposed card transactions based upon said placement information and said advertising agent information; and said card verification server configured to transmit each of said advertisements with said approval or said denial for said matched proposed transaction to said at least one receipt printing machine.
